(19) United States
(12) Patent Application Publication
(10) Pub. No.: US 2008/0196363 A1
(43) Pub. Date: Aug. 21, 2008

(54) Stirrup safety structure

(76) Inventor: Ju-Sung Chang, Nantou County (TW)

Correspondence Address: BACON & THOMAS, PLLC, 625 SLATERS LANE, FOURTH FLOOR, ALEXANDRIA, VA, 22314, US

(21) Appl. No.: 11/707,043

(22) Filed: Feb. 16, 2007

(51) Int. Cl. B68C 3/02

(52) U.S. Cl. 54/49

(57) ABSTRACT

The present invention relates to a stirrup safety structure, which is integrally formed and mainly composed of pedals and inverted U-shaped suspension locking racks. Wherein, appropriate number and shape of troughs are engraved on the pedal to limit the sticking on of mud. Moreover, a stopper ring is respectively set at the prefixed position of the lower section lying in between both ends of the suspension rack; appropriate numbers of movable pulleys are set at the lower rod between said stopper ring and pedal; said movable pulleys have the effect of free rotating. Hence, when a horse-rider falls down from the horseback, said movable pulley can enable the rider to free slip and withdraw his feet from stirrup smoothly, by means of said movable pulley's rubbing and revolving with the rider's feet and the momentum caused by the horse's running, to avoid his feet being hooked by the stirrup. Therefore the present invention can solve the problem of a horse-rider's being dragged along by the horse and get hurt when he falls down from the horseback and, therefore, becomes a simple and effective safety protection device.

### BACKGROUND OF THE INVENTION

1) Field of the Invention

The present invention relates to a stirrup safety structure; the safety-protecting device is developed for solving the problem aroused in a situation when a horse-rider is being dragged to get hurt by the horse after falling down from horseback. The design of the present safety structure is to set a movable pulley with the effect of free revolving at the lower section close to the pedals of the two ends of the suspension frames for the stirrup; the movable pulley can help a horse-rider's feet to smoothly move away from the stirrup when he falls down from horseback; hence, a horse-rider's feet will not be hooked by the stirrup and he will not be dragged and get hurt by the horse. The safety structure has an excellent merit on safety protection.

2) Description of the Related Art

Horse-riding is a sport of strength and beauty; it can not only train the sense of equilibrium, cadence and litheness, but also have the effect of rehabilitation for muscle and limbs. Moreover, it is an activity containing functions of exercise-taking, leisure-enjoying, pet-raising, and social-contacting, and appropriate for different ages of men and women. Hence, the activity can become a family activity; in some European and American countries, horse-riding has become a daily leisure sport.

However, when taking horse-riding exercise, the availability of outfit, e.g. saddle, protecting appliance, stirrup and reins, is a must for improving the comfort feeling of horse-riding. Wherein, stirrup is the most important appliance for a horse-rider; stirrup not only help a horse-rider to step on the horseback, but also help the horse-rider to maintain a stable and safe posture upon riding a horse by stepping his feet on the stirrup.

The structure design of such a stirrup is mainly formed by matching a long-shaped pedal with a collocating converted U-shaped suspension rack; furthermore, make use of the hole at the top end of the suspension rack for the suspension-belt to pass through and fasten. Then, mount it on the horseback to suspend the stirrups on two sides of the horse body respectively to complete the installment of the stirrup. Besides, protruding grains will be set on the surface of pedal for slip-proof.

However, such kind of stirrup can improve stability of the activity of horse-riding via accommodating the horse-rider's feet when riding on horseback to avoid his feet from following the horse's actions of running and jumping to sway randomly, but if the rider falls down from the horseback, this kind of stirrup may become a fatal crisis to the rider for being dragged along by the horse as a result of hooking by the stirrup. The reason is when riding on the horseback, the rider will step his feet on the stirrup and his heels will keep as close to the pedals as possible and the most part of his feet will be on the other end of the suspension rack; upon this horse-riding posture, when the rider is falling down carelessly from the horse, normally, he will not withdraw his feet from the stirrup in time and his feet will be hooked by the stirrup and his body will be dragged along by the horse to get hurt seriously, and in some case, the situation will even become fatal.

### SUMMARY OF THE INVENTION

The major purpose of the present invention is to improve a safety structure of stirrup, from which horse-rider's feet can slip out when he falls down from horseback to avoid being dragged along by the horse to get hurt. Hence, the present invention will be endowed with excellent value of safety and protection.

The other purpose of the present invention is to improve a safety structure of stirrup; wherein, via the design of structure, the problem of mud stained and being stuck on the pedals of the stirrup can be solved besides the stirrup is being endowed with excellent value of safety and protection when a horse-rider is falling down from the horseback.

For achieving said purposes, the structure design of the present invention is mainly composed of pedals and inverted U-shaped suspension racks. Wherein, appropriate number and shape of troughs are engraved on the top surface of said pedals. In addition, appropriate number of outwardly rib grain is also set to limit mud's sticking on. Moreover, a stopper ring is respectively set at the prefixed position of the lower section at both ends of the suspension rack; appropriate number of movable pulleys are set at the lower rod between said stopper ring and pedal; inner diameter of said movable pulley is a bit bigger than the diameter of the lower rod of the suspension rack to enable the movable pulley to have the effect of free rotating. Hence, when a horse-rider falls down from the horseback, said movable pulley can enable the rider to slip freely and withdraw his feet from the stirrup smoothly to avoid his feet from being hooked by the stirrup and thus being dragged along by the horse to get hurt.

### BRIEF DESCRIPTION OF THE DRAWINGS

Other features and advantages of the present invention will become apparent in the following detailed description of the preferred embodiments, with reference to the accompanying drawings, in which:

FIG. 1 is a schematic view of the structure of preferred embodiment of the invention.

FIG. 2 is a schematic view of the exploded structure of preferred embodiment of the invention.

FIG. 3 is a schematic view of the structural relation of preferred embodiment of the invention.

FIG. 4 is a schematic view of the structural action relation illustration of the feet's automatically slipping and withdrawing from the stirrup of the present invention.

FIG. 5 is a schematic view of another visual structural action relation of the feet's automatically slipping and withdrawing from the stirrup of the present invention.

### DETAILED DESCRIPTION OF THE PREFERRED EMBODIMENTS

In the detailed description of the preferred embodiments, it should be noted that like elements are indicated by the same reference numerals throughout the disclosure.

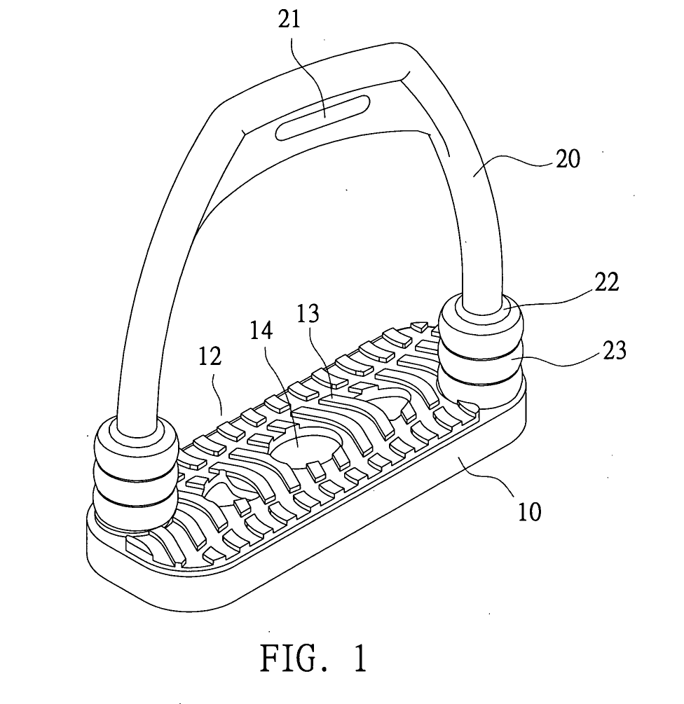

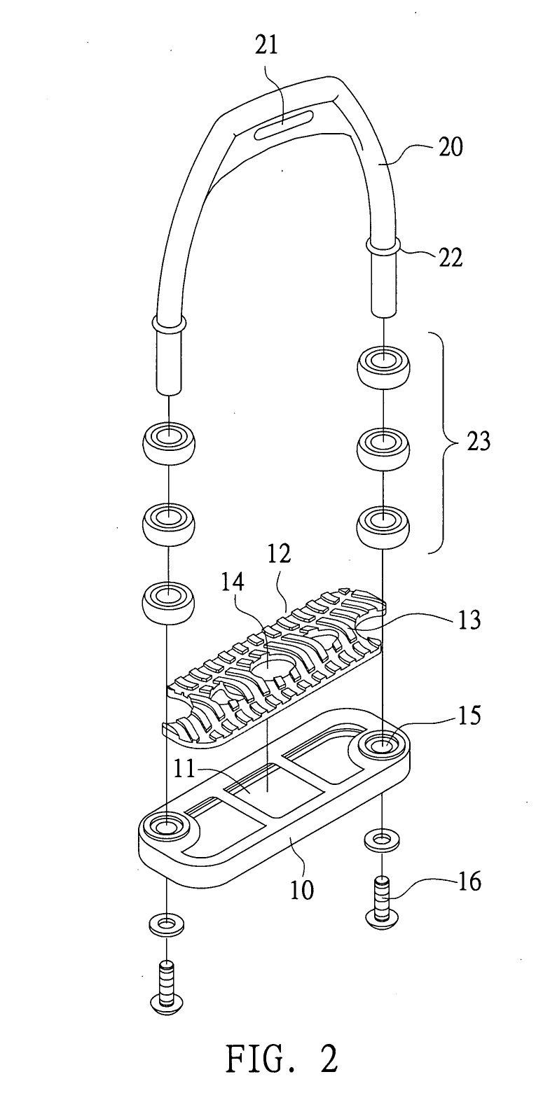

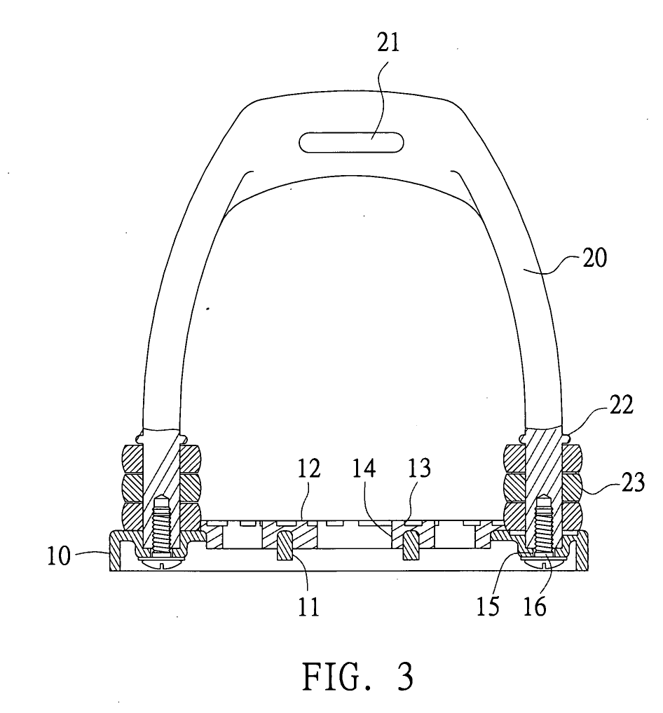

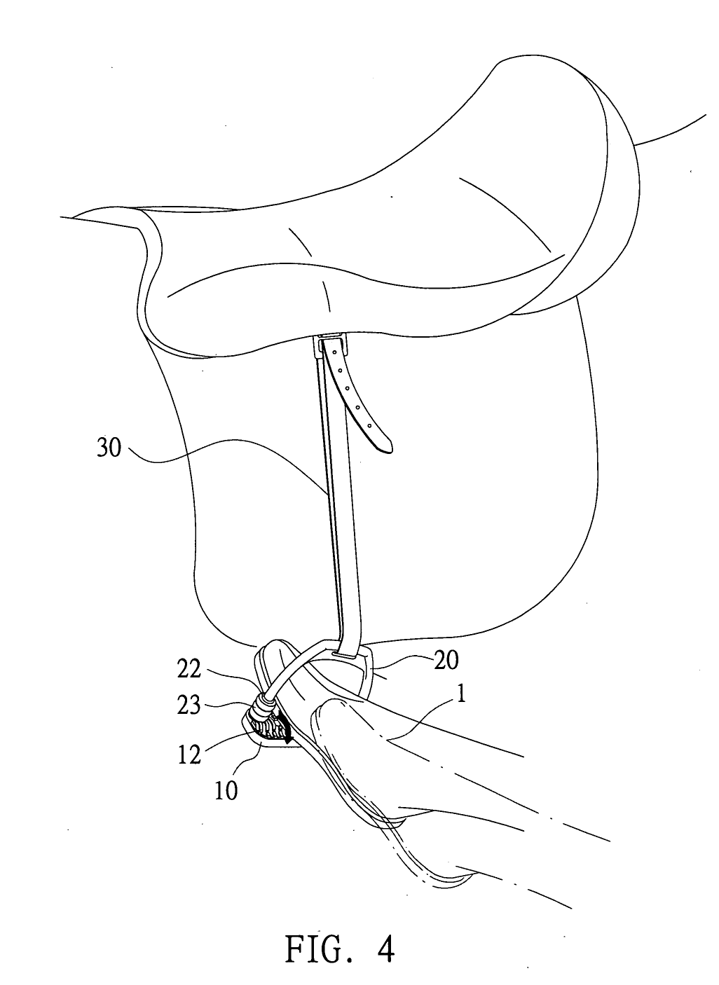

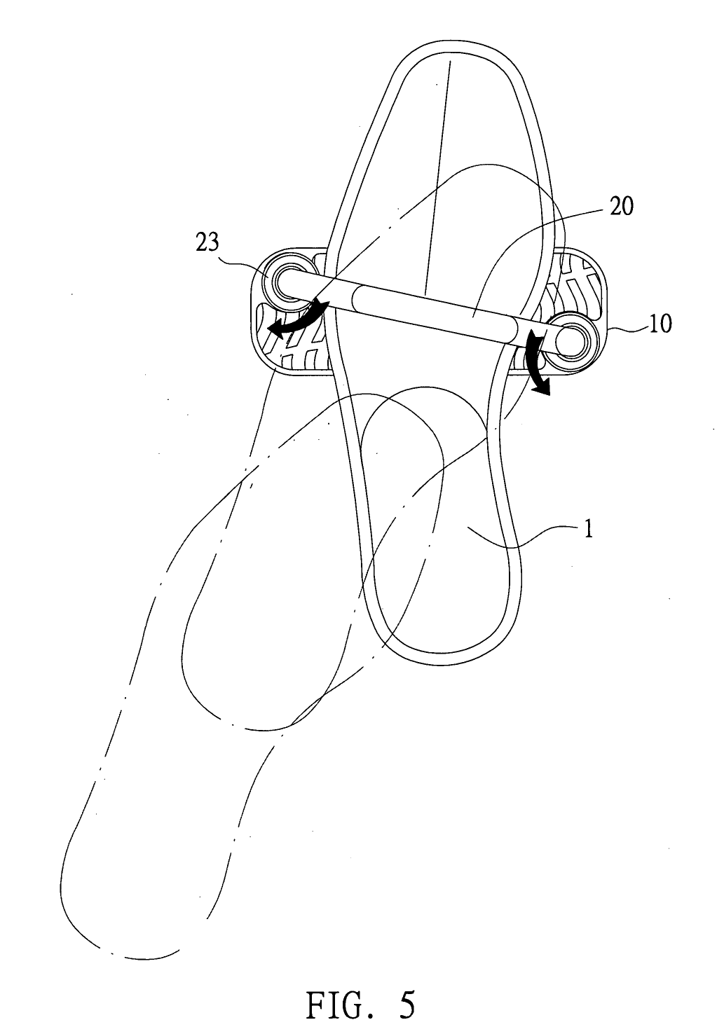

Refer to FIGS. 1, 2, 3, 4 and 5, as shown in figures, the structure design of the present invention preferred embodiment is mainly composed and shaped by pedal 10 and roughly inverted U-shaped suspension racks 20. Wherein, said pedal 10 is a long plate, several troughs 11 is engraved to embed one elastic gasket 12 on the top surface of said pedal 10; appropriate number and shape of outwardly rib grains 13 are set on the top surface of the said elastic gasket 12; furthermore, set appropriate number and shape of engraved aperture-trough 14 are set at the position where elastic gasket 12 is corresponding to pedal 10; set bole holes 15 at both ends of said pedal 10 for the fixing of bolts 16 at both ends of the suspension rack 20 from underneath. The aforesaid suspension rack 20 is roughly inverted U-shaped rack; top of said rack is flat and set with a fastening hole 21 for the passing through and fastening suspension-belt's 30; besides, a stopper ring 22 is respectively set at the expected position of the lower section at both ends of the suspension rack; appropriate number of movable pulleys 23 are set at the lower rod between said stopper ring 10 and pedal 22; inner diameter of said movable pulley 23 is a bit bigger than the diameter of lower rod of the suspension rack 20 but a bit smaller than stopper ring 22 to make said movable pulley 23 be limited at the region between pedal 10 and stopper ring 22 when said suspension rack 20 and pedal 10 are bolted and fixed by blot 16, and, moreover, it enable said movable pulley 23 to have the effect of freely rotating. On the basis of foregoing description, the stirrup of the present invention has thus been structured.

Upon normally applying the safe stirrup of the present invention, said movable pulley 23 set at both ends of said suspension rack 20 will not affect the function of the rider's feet for stepping and leaning; however, when a horse-rider falls down from the horseback, said movable pulley 23 can enable the rider to slip freely and withdraw his feet from the stirrup smoothly, by means of rubbing and revolving said movable pulley 23 with rider's feet 1 and the momentum caused by horse's running To avoid his feet from being hooked by said suspension rack 20 of the stirrup and being dragged along by the horse to get hurt. Hence, the present invention will be endowed with excellent value of safety and protection.

Furthermore, the present invention of safety stirrup makes use of the outwardly raised rib grains 13 set on elastic gasket 12 on the top surface of pedal 10 to increase the effect of slip-proof; what's more, upon stepping on pedal 10 after walking on muddy way on rainy day, drain mud away via said engraved troughs 14 to dramatically improve the problem of mud's sticking on said pedal.

From above description, it is known that the design of a safety structure of stirrup of the present invention has the movable pulleys set on both ends of the suspension rack besides setting engraved troughs to decrease the problem of mud's sticking on. When horse-rider falls down from horseback, his feet will automatically and smoothly withdraw out of the stirrup by the action of said movable pulleys to avoid his feet from being hooked by the stirrup to let him be dragged along by the horse to get hurt. Hence, the present invention will be endowed with appropriate safety and protection effects and become an ideal and practical “safe” stirrup.

Integrating foregoing description, the present invention focuses on improving the derived problems caused by existing stirrup when a horse-rider falls down from the horseback accidentally, since it is lack of safety protection. The present invention endows the effect of enabling his feet's withdraw automatically from the stirrup to assure the rider from being dragged along by the horse to get hurt when falling down from the horseback accidentally.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

What is claimed is:

1. A stirrup safety structure which is mainly composed and shaped by a long pedal and roughly inverted U-shaped suspension rack; wherein, said pedal has outwardly raised rib grains set on the top surface; bolt holes are set at both ends of said pedal for bolts' fixing both ends of the suspension rack from underneath; fastening hole is set on the top of said rack for the passing through of the suspension belt and fastening both ends of said rack; the feature is:
a stopper ring is respectively set at the prefixed position of the lower section of both ends of the suspension rack; appropriate number of movable pulleys are set at the lower rod between said stopper ring and aforesaid pedal; said movable pulley have the effect of free rotating; when a horse-rider falls down from the horseback, by means of said rubbing and revolving pf the movable pulley with the rider's feet and the momentum caused by horse's running, the rider can withdraw his feet from stirrup to avoid his feet from being hooked by the stirrup and dragged along by the horse to get hurt. Hence, the present invention will achieve the effect of safety and protection.

2. A stirrup safety structure as claimed in claim 1, wherein said inner diameter of movable pulley set at the lower end of suspension rack is a bit bigger than the diameter of the lower rod of the suspension rack but a bit smaller than stopper ring to make said movable pulley be limited at the region between the pedal and the stopper ring when said suspension rack and pedal are bolted and fixed by blot, and moreover, it enable said movable pulley to have the effect of free rotating.

3. A safety structure of stirrup as claimed in claim 1, wherein said outwardly raised rib grains is set on the top surface of pedal; what's more, engraved troughs are set to limit mud's sticking on said pedal.

4. A stirrup safety structure as claimed in claim 1, wherein said pedal is a long plate, which is engraved to several troughs to embed one elastic gasket on the top surface of said pedal; outwardly raised rib grains are set on the top surface of the said elastic gasket; furthermore, engraved aperture-troughs are set at the position where elastic gasket is corresponding to the pedal trough.
